(19) United States
(12) Patent Application Publication
(10) Pub. No.: US 2012/0052783 A1
(43) Pub. Date: Mar. 1, 2012

(54) REDUCED-EMISSION FUME HOOD

(76) Inventor: Vincent H. Reynolds, East Syracuse, NY (US)

(21) Appl. No.: 12/862,370

(22) Filed: Aug. 24, 2010

(51) Int. Cl. B08B 15/02

(52) U.S. Cl. 454/56

(57) ABSTRACT

A fume hood is provided that can reduce emissions. The fume hood has a work chamber with a front side and an exhaust opening. The front side has an upper shield and a sash below the upper shield. The sash comprises at least one sash shield, wherein the at least one sash shield at least partially defines at least one sash opening in the front side to allow access to the work chamber.

### BACKGROUND OF THE INVENTION

The subject matter disclosed herein relates to fume hoods, and more particularly to reduced-emission fume hoods.

A fume hood is a type of local ventilation device that is designed to limit the user's exposure to hazardous or noxious fumes, vapors or dusts. Fume hoods are commonly used in laboratories where hazardous or noxious chemicals are released during testing, research, development, or teaching. Fume hoods are also used in industrial applications or other activities where hazardous or noxious vapors, gases, or dusts are generated or released.

A fume hood can enclose five sides of a work chamber, the bottom of the work chamber having a work surface, which is located at a work height for the user, whether sitting, standing, or otherwise. The front side of the work chamber has an opening, called a sash. The sash is open to the room occupied by the fume hood and the user so that the user can access the work chamber enclosed by the fume hood. Some sashes can be closed when the fume hood is not in use.

The top side or one of the lateral sides near the top side of the work chamber, has a vent to expel contaminated air containing the hazardous or noxious fumes, vapors, or dusts. The contaminated air can be expelled, for example, through a duct to the outside of a building in which the fume hood is contained. While air is expelled through the vent, fresh air is drawn into the fume hood through the sash.

The proper flow of fresh air into the fume hood through the sash and/or other inlet vents, and of contaminated air out of the fume hood from the work chamber through the vent, is essential to the proper functioning of the fume hood in expelling dangerous air and in protecting the user and/or other individuals in the room from inhaling contaminants. Fume hoods are intended to reduce, minimize, or prevent contaminated air from flowing or leaking into the room where a user or other individuals can be exposed. To reduce or prevent leaking through the sash, safety regulations and industry standards require a minimum velocity of air along the surface of the sash. This velocity is referred to as a face velocity. If the standard of ASHRAE 110 “Method of Testing Performance of Laboratory Fume Hoods” and NFPA 45 “Standard on fire protection for laboratories using chemicals” 2004 edition are met, then a face velocity between 80 ft/min and 120 ft/min (≈0.4 m/s to ≈0.6 m/s) can contain gases in the fume hood.

In order to maintain a proper face velocity, a significant amount of air is circulated into and through the fume hood. In one example, a five foot long fume hood with a 14 inch by 56 inch sash (0.3556 meters by 1.4224 meters), and a face velocity of about 120 ft/min (≈0.6 m/s) at the sash, nominally exhausts about 800 cubic feet of air per minute (CFM) (22.64 cubic meters per minute) from the work surface and another 80 CFM (2.264 cubic meters per minute) from a connected storage cabinet. Large quantities of energy and money are required to run fans that move this air through the fume hood. Furthermore, the air that is circulated into the fume hood from the room or laboratory is conditioned to control humidity, temperature, and/or composition (e.g. cleanliness) as the air conditions are important in many laboratory environments or other environments where fume hoods are used. Often, many fume hoods are in use simultaneously in a room or laboratory, which multiplies the amount of conditioned air moved through the fume hood and exhausted from the room and/or building. Since conditioning air costs a significant amount of energy and money, moving less air through the fume hood while maintaining the face velocity can provide significant savings.

One method that attempts to reduce the expense associated with moving conditioned air through the fume hood transfers air from outside the building through ducts, and outputs the air directly in front of the fume hood, where it can be drawn into the fume hood. This method increases the costs in ductwork, and delivers unconditioned air that can be too hot, too cold, or too humid, which is uncomfortable to a user and unacceptable for many procedures in the fume hood.

Another method uses a variable air volume (VAV) system, which reduces the volume of the air exhausted as the fume hood sash is closed. The VAV system is often enhanced by an automatic sash closing device, which will close the fume hood sash when the user leaves the fume hood face. This fume hood attempts to minimize the exhaust volume whenever no one is actually working with hands in the fume hood through the sash. However, it does not minimize or reduce the exhaust during use.

It would be advantageous to provide a fume hood that reduces the expenditure of energy during active use, without reducing the face velocity and without using unconditioned air.

### BRIEF DESCRIPTION OF THE INVENTION

In one embodiment, a fume hood comprises a work chamber with a front side and an exhaust opening. The front side has an upper shield and a sash below the upper shield. The sash comprises at least one sash shield, the at least one sash shield being slidable and at least partially defining at least one adjustable sash opening in the front side to allow access to the work chamber.

In another embodiment, a fume hood comprises a work chamber partially enclosed by a bottom work surface, a first side panel, a second side panel, a top side panel, a back side panel, and a front side. The fume hood also comprises an exhaust opening in one of the first side panel, the second side panel, the top side panel, and the back side panel. The front side comprises an upper shield and a sash below the upper shield. The sash further comprises a first end sash shield, a second end sash shield, and at least one center sash shield between the first end sash shield and the second end sash shield. The first end sash shield and the at least one center sash shield at least partially define a first opening in the front side to allow manual access to the work chamber. The second end sash shield and the at least one center sash shield at least partially define a second sash opening in the front side to allow manual access to the work chamber.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of invention. Thus, for further understanding of the invention, reference can be made to the following detailed description, read in connection with the drawings in which:

FIG. 1 is a perspective view of a fume hood in one exemplary embodiment of the invention.

FIG. 2 is a perspective view of a fume hood in another exemplary embodiment of the invention.

### DETAILED DESCRIPTION OF THE INVENTION

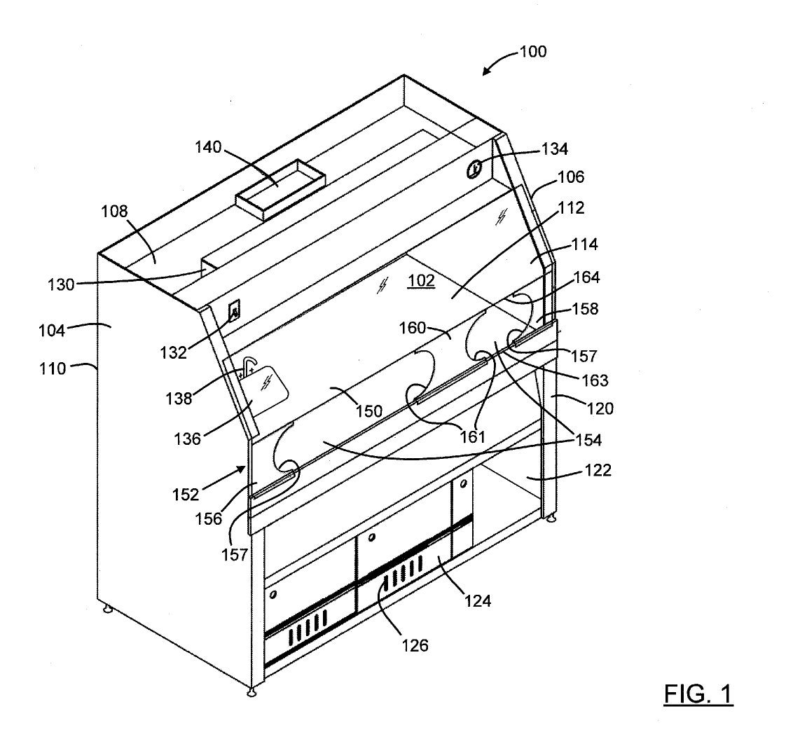

FIG. 1 is a perspective view of a fume hood 100 in one exemplary embodiment of the invention. The fume hood 100 can comprise a work chamber 102 defined by a first side panel 104, a second side panel 106, a top side panel 108, a back side panel 110, a bottom side panel 112, and a front side 114. The bottom side panel 112 can be used as, or can have, a work surface. The fume hood 100 can be supported by a base 120. The base 120 can contain cabinets 122 for storage of solvents and/or other materials used in the hood's work chamber 102. The cabinets 122 can be fluidly connected to the work chamber 102, meaning gases and other fluids can flow between the cabinets 122 and the work chamber 102. The cabinets 122 can have cabinet doors 124 with vents 126. The fume hood 100 can be sized variously. Typical lengths of the fume hood 100 between the first side panel 104 and the second side panel 106 can be between 3 feet and 8 feet (0.9144 meters and 2.4484 meters) in length (e.g. distance between the first side panel 104 and the second side panel 106), but the fume hood 100 can also be shorter or longer. Typical depths of the fume hood 100 between the front side 114 and the back side panel 110 can be between 30 inches and 48 inches (0.762 meters and 1.2192 meters), although the fume hood can have smaller or larger depths.

The fume hood 100 can comprise features to enhance the work chamber 102 and/or operator experience. For example, the fume hood can comprise lights 130, light switches 132, an exhaust monitor 134, a sink 136, and a faucet 138. Temperature sensors, humidity sensors, and other gauges and sensors can also be used. Many other options can be incorporated as well.

An exhaust opening 140 can be positioned in one of the panels 104, 106, 108, 110. The exhaust opening 140 can connect the work chamber 102 to exhaust ducts (not shown), which allow air to flow from the work chamber 102 and cabinets 122 and be expelled or exhausted to a desired location, such as an area outside of a building in which the fume hood 100 is located. Air blowers (not shown) can provide the motive force to move the air in the proper direction out of the work chamber 102 through the exhaust opening 140.

The front side 114 can connect to the first side panel 104, the second side panel 106, the top side panel 108, and the bottom side panel 112. The front side 114 can comprise an upper safety shield 150 and a sash 152. The upper safety shield 150 can be perpendicular to the top side panel 108, or as shown in FIG. 1, the upper safety shield 150 can be angled nonperpendicularly with the top side panel 108, such as at an angle between 30 degrees and 60 degrees. A nonperpendicularly angled upper safety shield 150 can enable an operator facing the work chamber 102 to lean the operator's upper body and/or head toward, and even over the work chamber 102. Allowing the operator to lean forward can enable better access (e.g. longer reach into the work chamber 102) and/or better viewing of the work chamber 102.

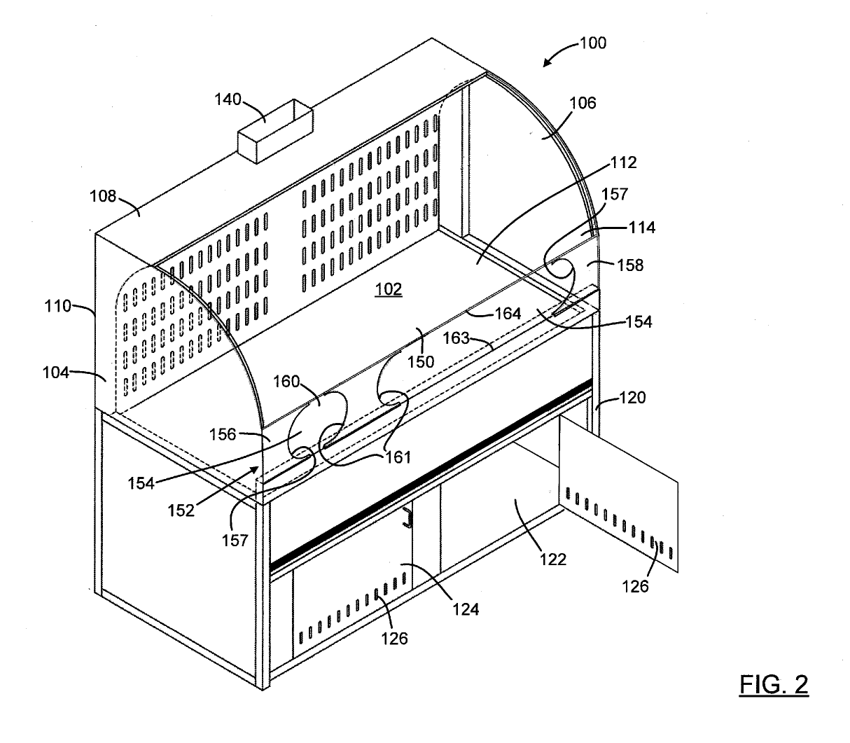

The upper safety shield 150 can be substantially flat or planar, as shown in FIG. 1. Alternatively, as seen in FIG. 2, which is a perspective view of a fume hood in one exemplary embodiment of the invention, the upper safety shield 150 can curve from the sash 152 to the top side panel 108. The curved shape of the upper safety shield 150 can be ergonomic, permitting an operator to lean forward toward the work chamber 102 and permitting easier reach into the work chamber 102. Also, the upper safety shield 150 can extend parallel, or close to parallel (e.g. horizontally or close to horizontally) with the top side panel, which can enable an operator better viewing of the work area 102 from the operator's non-leaning position, or as the operator leans forward over the work chamber 102.

The upper safety shield 150 can be fixed in place and can be unmovable during normal operation, or the upper safety shield 150 can be configured to be moveable during normal operation. For example, the upper safety shield 150 can be hinged at the top edge near the top side panel 108, so that the upper safety shield 150 can be opened outward and upward from the bottom edge near the sash 152. The upper safety shield 150 can also be hinged on any of the other three edges of the upper safety shield 150. A moveable (e.g. openable) upper safety shield 150 can allow the upper safety shield 150 to be closed a maximal amount of time, and/or while harmful fluids are in the work chamber 102, and then opened to allow an operator easier access for tasks, such as cleaning or inserting or removing larger items that cannot fit through the sash 152. A movable upper safety shield 150 can allow greater access to the work area 102 when it is not necessary to have the upper safety shield 150 closed to maintain adequate air flow and to protect an operator from dangerous solvent splashes or other hazards.

The sash 152 can comprise two sash openings 154, a first end lower safety shield 156, a second end lower safety shield 158, and a center lower safety shield 160. The sash 152 can be bounded above by the upper safety shield 150, on the sides by the first side panel 104 and the second side panel 106, and below by the bottom side panel 112, the base 120 and/or the cabinets 122. The size of the sash 152 can vary, depending at least in part on the size of the fume hood 100. For example, the length of the sash 152 can be up to the full length of the fume hood 100. In one embodiment, the sash height is approximately 10 inches (0.254 meters).

The first end lower safety shield 156 and the second end lower safety shield 158 can be fixed in place, while the center lower safety shield 160 can be movable. In one embodiment, the center lower safety shield 160 can slidably rest on a lower rail 163, with the upper edge of the center lower safety shield 160 slidably engaging the upper safety shield 150 or an upper rail 164 that engages the upper safety shield 150. Each lower safety shield 156, 158, 160 can be a panel of clear, solid material (e.g. glass or plexiglass). The sash openings 154, which can be adjusted by the movement of the center lower safety shield 160, are defined by the center lower safety shield 160 and each of the end lower safety shields 156, 158.

One sash opening 154 can be enlarged while the other sash opening 154 can be reduced, by moving the center lower safety shield 154 toward the first side panel 104 or toward the second side panel 106. The center lower safety shield 160 can have a curved or semicircular cutout 161 on either or both of the laterally peripheral edges of the center lower safety shield 160. Each end lower safety shield 156, 158 can also have a curved or semicircular cutout 157 on the edge facing the center lower safety shield 160. When the lower safety shields 156, 158, 160 have cutouts 157, 161, the center lower safety shield 160 and either of the end lower safety shields 156, 158 can be brought together while maintaining a sash opening 154 large enough to provide manual access to the work chamber 102. For example, with a ten inch high sash and ten inch high lower safety shields 156, 158, 160, the radius of the cutout 157, 161 can be 4.5 inches (0.1143 meters), and the cutout can be a half circle, leaving a straight edge 0.5 inches (0.0127 meters) long immediately above and immediately below the cutout. When the center lower safety shield 160 abuts either end lower safety shield 156, 158 at the 0.5 inch (0.0127 meters) long straight edge, then there is a 9 inch (0.2286 meters) circular opening 154 between the center lower safety shield 160 and the end lower safety shield 156, 158. The circular opening 154 allows an operator equal freedom of movement in all directions. In other embodiments, the cutout 157, 161 is not a half circle. The cutouts 157, 161 can also have smaller radiuses than 4.5 inches (0.1143 meters), leaving longer straight edges than 0.5 inches (0.0127 meters); and the cutouts 157, 161 can have radiuses as large as half the sash height or larger with no straight edge immediately above or below the cutouts 157, 161. The lower safety shields can have various lengths. In one embodiment, the end lower safety shields 156, 158 can be 10 inches long (0.254 meters), and the center lower safety shield can be 16 inches long (0.4064 meters). The particular size and shape of the lower safety shields 156, 158, 160 can be varied to accommodate various fume hood sizes and designs, in order to achieve the proper face velocity and air flow conditions.

In one embodiment, the first end lower safety shield 156 and the second end lower safety shield 158 can be movable also. For example, the end lower safety shields 156, 158 can slidably rest on the lower rail 163, with the upper edge of the end lower safety shields 156, 158, slidably engaging the upper safety shield 150 or an upper rail 164 that engages the upper safety shield 150. Having slidable end lower safety shields 156, 158 can provide an operator with more leeway in accessing the work chamber 102. For example, slidable end lower safety shields 156, 158 can enable easier access to the work chamber 102 close to the first side panel 104 or the second side panel 106.

The lower safety shields 156, 158, 160, lessen the total open area of the sash 152 while simultaneously allowing an operator to access and work in the work chamber 102 with the operator's hands and/or arms through the sash openings 154. Because the total open area of the sash 152 is lessened, a lesser volume of air can be drawn into the fume hood 100 and exhausted from the fume hood 100, while maintaining an adequate face velocity. For example, a 5 foot (1.524 meter) long fume hood 100 with a 4 inch by 12 inch (0.1016 meter by 0.3048 meter) exhaust opening 140, a 30 inch deep by 60 inch long (0.762 meter deep by 1.524 meter long) work surface, a 35 inch deep by 36 inch high (0.889 meter deep by 0.9144 meter high) vented storage cabinet 122, and a sash 152 10 inches high by 60 inches long (0.254 inches high by 1.524 meters long), with two end lower safety shields 156, 158 and one center lower safety shield 160, where the end lower safety shields 156, 158 are 10 inches (0.254 meters) square with a 4.5 inch (0.1143 meter) radius cutout 157, and where the center lower safety shield 160 is 16 inches (0.4064 meters) wide with two 4.5 inch (0.1143 meter) radius cutouts 161, the face velocity can be maintained approximately at or above 80 ft/min to 120 ft/min (≈0.4 m/s to 0.6 m/s). In this example, the sash 152 has a total area of 600 square inches (≈0.387 square meters). The sash openings 154 account for approximately 367 square inches (≈0.237 square meters) and the lower safety shields 156, 158, 160 account for approximately 233 square inches (≈0.150 square meters) of area. At about 120 ft/min (≈0.6 m/s), the air exhausted from the work chamber 102 can be approximately 330 CFM (9.339 cubic meters per minute), while the air exhausted from the storage cabinets 122 can be approximately 15 CFM (0.4245 cubic meters per minute), for a total amount of air exhausted equal to about 345 CFM (≈9.763 cubic meters per minute).

In addition to reducing the volume of air flowing through the fume hood 100, the lower safety shields 156, 158, 160 act as physical barriers to protect an operator from dangerous fluid splashes or other physical harms. In particular, the center lower safety shield 160 and configuration with one sash opening 154 on each side of the center lower safety shield 160, positions an operator in front of the center lower safety shield 160 while the operator places a hand through one or both sash openings 154. Otherwise, an operator can stand to the side of the fume hood 100, in front of either end lower safety shield 156, 158 and place one hand through only one sash opening 154. In the latter case, the end lower safety shield 156, 158 can protect the operator.

In some embodiments, there can be more than one center lower safety shield 160. For example, in a relatively large fume hood, two or more center lower safety shields 160 can accommodate multiple operators working at the fume hood 100 and within the work chamber 102 simultaneously.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A fume hood comprising:
a work chamber partially enclosed by a bottom work surface, a first side panel, a second side panel, a top side panel, a back side panel, and a front side;
an exhaust opening in one of the first side panel, the second side panel, the top side panel, and the back side panel;
an upper shield on the front side; and
a sash below the upper shield on the front side of the fume hood, wherein the sash further comprises a first end sash shield, a second end sash shield, and at least one center sash shield between the first end sash shield and the second end sash shield, the first end sash shield and the at least one center sash shield at least partially defining a first opening in the front side to allow manual access to the work chamber, and the second end sash shield and the at least one center sash shield at least partially defining a second sash opening in the front side to allow manual access to the work chamber.

2. The fume hood of claim 1, wherein the at least one center sash shield is moveable from a first position to a second position laterally spaced from the first position.

3. The fume hood of claim 2, wherein the at least one center sash shield is moveable by being slidable on an axis extending between the first end sash shield and the second end sash shield.

4. The fume hood of claim 1, wherein the end sash shields are moveable, each from a first position to a second position laterally spaced from the first position.

5. The fume hood of claim 4, wherein the end sash shields are moveable by being slidable on an axis extending between the first end sash shield and the second end sash shield.

6. The fume hood of claim 1, wherein the at least one center sash shield has at least one lateral edge concavely rounded.

7. The fume hood of claim 6, wherein the concavely rounded edge defines a half circle.

8. The fume hood of claim 1, wherein the end sash shields each have at least one lateral edge concavely rounded.

9. The fume hood of claim 8, wherein the concavely rounded edge defines a half circle.

10. The fume hood of claim 1, further comprising a plurality of center sash shields between the first end sash shield and the second end sash shield, wherein each center sash shield in the plurality of center sash shields is spaced apart from a neighboring center sash shield in the plurality of center sash shields to at least partially define a first opening in the front side to allow manual access to the work chamber.

11. A fume hood comprising:
a work chamber having a front side and an exhaust opening;
an upper shield on the front side; and
a sash below the upper shield on the front side of the fume hood, wherein the sash further comprises at least one sash shield, the at least one sash shield being slidable and at least partially defining at least one adjustable sash opening in the front side to allow access to the work chamber.

12. The fume hood of claim 11, wherein the at least one sash shield has at least one round cutout section.

13. The fume hood of claim 11, wherein the rounded cutout section is the shape of a half circle.

14. The fume hood of claim 11, wherein the at least one sash shield has at least one lateral edge concavely rounded.

15. The fume hood of claim 14, wherein the concavely rounded edge defines a half circle.
